(19) United States
(12) Patent Application Publication
(10) Pub. No.: US 2008/0221795 A1
(43) Pub. Date: Sep. 11, 2008

(54) Processing Electromagnetic Data

(75) Inventors: Lasse Amundsen, Trondheim (NO); Egil Holvik, Trondheim (NO)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignees: STATOIL ASA, Stavenger (NO); ELECTROMAGNETIC GEOSERVICES AS, Trondheim (NO)

(21) Appl. No.: 11/630,526

(22) PCT Filed: Jun. 16, 2005
(86) PCT No.: PCT/EP05/52781

§ 371 Date: Mar. 7, 2007

(30) Foreign Application Priority Data
Jun. 26, 2004 (GB) 0414373.1

(51) Int. Cl. G01V 3/38

(52) U.S. Cl. 702/5

(57) ABSTRACT

A method for processing multi-component, multi-offset electromagnetic data measured at at least one multi-component receiver, the data representative of electric and magnetic fields due to a source, the at least one multi-component receiver being disposed at a depth greater than that of the source. The method includes decomposing the measured multi-offset electric and magnetic fields into upgoing and downgoing components; and formulating a noise removal operator from the downgoing components and the properties of the medium surrounding the at least one receiver.

The present invention relates to the processing of electromagnetic data. In particular, the present invention is concerned with the calculation of a noise removal operator that attenuates certain parts of an electromagnetic field.

The electromagnetic seabed logging (EM-SBL) technique is a new hydrocarbon exploration tool based on electromagnetic data, and is disclosed in Eidesmo et al., (2002) “Sea Bed Logging, a new method for remote and direct identification of hydrocarbon filled layers in deepwater areas”, The Leading Edge, 20, No. 3, 144-152 and in Ellingsrud et al., (2002) “Remote sensing of hydrocarbon layers by seabed logging SBL: Results from a cruise offshore Angola”, First Break, 21, No. 10, 972-982. EM-SBL is a special application of controlled-source electromagnetic (CSEM) sounding. CSEM sounding has been used successfully for a number of years to study ocean basins and active spreading centres. SBL is the first application of CSEM for remote and direct detection of hydrocarbons in marine environments. The two first successful SBL surveys published were offshore West Africa (Eidesmo et al and Ellingsrud et al above) and offshore mid-Norway, Rosten et al., (2003) “A Seabed Logging Calibration Survey over the Ormen Lange gas field”, EAGE, ₆₅^{th} An. Internat. Mtg., Eur. Assoc. Geosc. Eng., Extended Abstracts, P058. Both studies were carried out in deep water environments (greater than 1,000 metre water depth).

The method uses a horizontal electrical dipole (HED) source that emits a low frequency electromagnetic signal into the underlying seabed and downwards into the underlying sediments. Electromagnetic energy is rapidly attenuated in the conductive subsurface sediments due to water-filled pores. In high-resistance layers such as hydrocarbon-filled sandstones and at a critical angle of incidence, the energy is guided along the layers and attenuated to a lesser extent. Energy refracts back to the seabed and is detected by electromagnetic receivers positioned thereupon. When the source-receiver distance (i.e. the offset) is of the order of 2 to 5 times the depth of the reservoir, the refracted energy from the resistive layer will dominate over directly transmitted energy. The detection of this guided and refracted energy is the basis of EM-SBL.

The thickness of the hydrocarbon-filled reservoir should be at least 50 m to ensure efficient guiding along the high-resistance layer

The electromagnetic energy that is generated by the source is spread in all directions and the electromagnetic energy is rapidly attenuated in conductive subsea sediments. The distance to which the energy can penetrate into the subsurface is mainly determined by the strength and frequency of the initial signal, and by the conductivity of the underlying formation. Higher frequencies result in greater attenuation of the energy and hence a lower penetration depth. The frequencies adopted in EM-SBL are therefore very low, typically 0.25 Hz. The electric permittivity can be neglected due to the very low frequencies, and the magnetic permeability is assumed to be that of a vacuum, i.e. a non-magnetic subsurface.

In terms of numbers, a hydrocarbon-filled reservoir typically has a resistivity of a few tens of ohm-metres or more, whereas the resistivity of the over- and under-lying sediments is typically less than a few ohm-metres. The propagation speed is medium-dependent. In seawater, the speed is approximately 1,700 m/s (assuming a frequency of 1 Hz and a resistivity of 0.3 ohm-m), whereas a typical propagation speed of the electromagnetic field in water-filled subset sediments is about 3,200 m/s, assuming the same frequency and resistivity of around 1 ohm-m. The electromagnetic field in a high-resistance hydrocarbon-filled layer propagates at a speed of around 22,000 m/s (50 ohm-m resistivity and 1 Hz frequency). The electromagnetic skin depths for these three cases are approximately 275 m, 500 m and 3,600 m, respectively.

The electromagnetic receivers may be placed individually on the seabed, each receiver measuring two orthogonal horizontal components and one vertical component of each of the electric and magnetic fields. The HED source consists of two electrodes approximately 200 m apart, in electrical contact with the seawater. The source transmits a continuous and periodic alternating current signal, with a fundamental frequency in the range of 0.05-10 Hz. The peak-to-peak AC ranges from zero to several hundred amps. The height of the source relative to the seabed should be much less than the electromagnetic skin depth in seawater to ensure good coupling of the transmitted signal into the subsurface, e.g. around 50-100 m. There are several ways of positioning the receivers on the seabed. Usually, the receivers are placed in a straight line. Several such lines can be used in a survey and the lines can have any orientation with respect to each other.

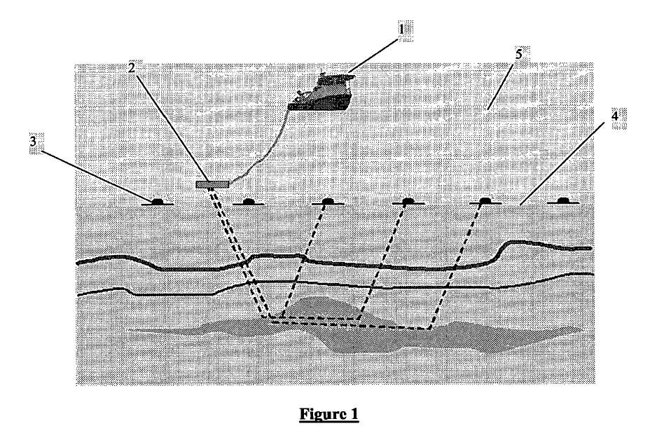

The environment and apparatus for acquiring EM-SBL data are illustrated in FIG. 1. A survey vessel 1 tows the electromagnetic source 2 along and perpendicular to the lines of receivers 3, and both in-line (transverse magnetic) and broad-line (transverse electric) energy can be recorded by the receivers. The receivers on the seabed 4 record data continuously while the vessel tows the source at a speed of 1-2 knots. The EM-SBL data are densely sampled at the source side, typically sampled at 0.04 s intervals. On the receiver side, typical receiver separation distance is approximately 200-2,000 m. Standard processing and interpretation of the acquired data can be performed in the common receiver domain or in the common shot domain, as long as data are sampled according to the sampling theorem (see, for example, Antia (1991) “Numerical methods for scientists and engineers”, Tata McGraw-Hill Publ. Co. Limited, New Dehli).

The EM-SBL data are acquired as a time series and then processed using a windowed discrete Fourier series analysis (see, for example, Jacobsen and Lyons (2003) “The Sliding DFT”, IEEE Signal Proc. Mag., 20, No. 2, 74-80) at the transmitted frequency, i.e. the fundamental frequency or a harmonic thereof. After processing, the data can be displayed as magnitude versus offset (MVO) or phase versus offset (PVO) responses.

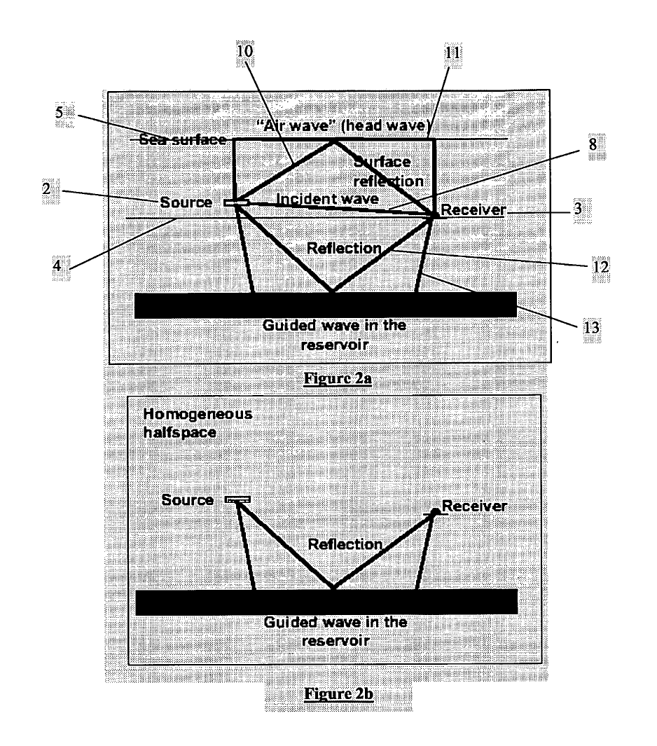

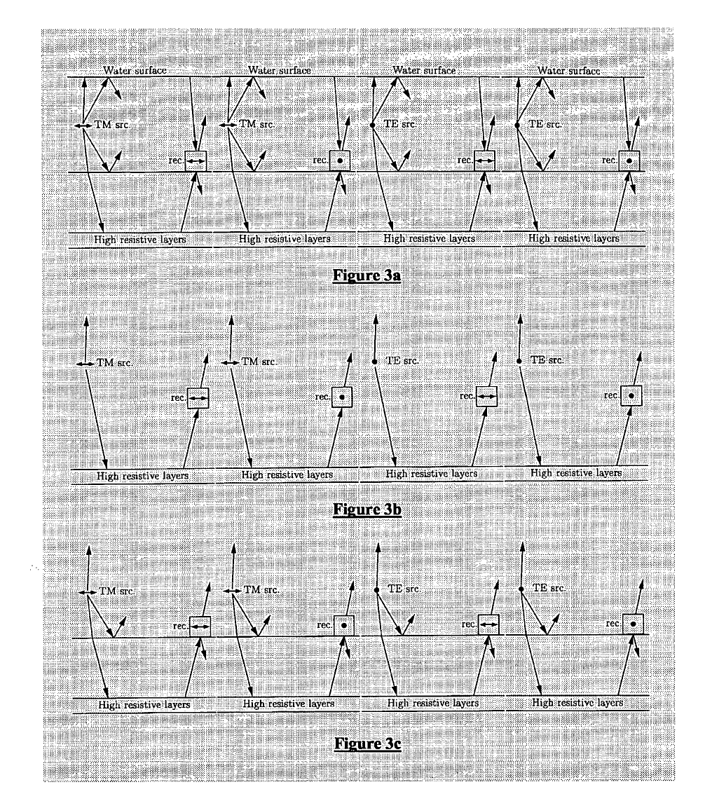

The principal wave types in the EM-SBL survey are illustrated in FIG. 2. The wave types of main interest for hydrocarbon mapping involve only a single reflection 12 and a single refraction 13 at the target. These are detected as upgoing events by the receiver 3. A problem that arises in electromagnetic marine surveying is that electromagnetic energy may travel from the source 2 to the receiver 3 along many paths. The direct wave 8 is a signal transmitted directly from the source 2 to the receiver 3. The direct wave dominates in amplitude at short source-receiver separations, but is strongly damped at larger offsets since sea water has a high conductivity. In shallow water, EM-SBL exploration is complicated by source-excited waves received at the receiver array as downward-traveling waves which have been refracted (wave 11) and totally reflected (wave 10) off the sea surface 5. The air wave 11 is the signal that propagates upwards from the source to the sea surface, horizontally through the air, and back down through the water column to the receiver. Due to the extreme velocity contrast between water and air, the critical angle for total reflection between sea water and air occurs at almost normal incidence. For angles of incidence greater than the critical angle, total reflection takes place, and the air volume acts as a perfect mirror for upgoing energy. The surface reflection 10 has its geometrical reflection approximately mid-way between the source and the receiver. In terms of signal strength at the receiver, the sea surface boundary is an efficient reflector at small to moderate offsets and an efficient refractor at larger offsets. The waves traveling downwards interfere with the upgoing waves from the subsurface.

Reflections and refractions from the sea surface represent a severe problem, particularly in shallow water electromagnetic exploration. If the sea surface reflections and refractions are not sufficiently attenuated, they will interfere and overlap with primary reflections and refractions from the subsurface.

In general, the water layer introduces a number of additional unwanted events that may interfere and overlap with primary reflections and refractions from the subsurface. A noise removal operator for removing unwanted events will be described below. The noise removal operator may also be known as a designature and denoise operator and is effective at substantially attenuating or completely removing the effects of the water layer present above the plane of the receivers in a typical EM-SBL environment. The operator is effective at removing from electromagnetic data all events associated with any interface above the level of the receivers or with any interface at the receiver level. The operator is also effective at attenuating or removing the effects of the source radiation from the data.

All energy and events caused by the medium above the receiver level will be referred to as “noise”.

In order to provide accurate information about the subsurface target, it is desirable to be able to identify and substantially attenuate the incident wavefield due to the source and the noise from reflected and refracted waves received at the receiver. An important part of any method for attenuating the source and noise wavefields will involve decomposing electromagnetic energy acquired at the receiver into its upgoing and downgoing constituents. There are two known approaches for this, see Amundsen, L., 2003, Method for Electromagnetic Wavefield Resolution (WO 03/100467), and co-pending British Patent Application No. 0407696.4.

U.S. Pat. No. 4,168,484 discloses a method for determining continuous and discontinuous impedance transitions in various media. The method involves disposing a source of electromagnetic radiation vertically above a number of receivers. Signals due to the source and due to reflections of media interfaces are recorded at the receivers and used to compute the incident and reflected waves, the incident and reflected waves being deconvolved to obtain the reflection impulse response. The reflection impulse response can be integrated to give the impedance transitions.

According to a first aspect of the invention, there is provided a method as defined in the appended claim 1.

Further aspects and embodiments of the invention are defined in the other appended claims.

It is thus possible to provide a method which permits substantial attenuation of source and other noise components in electromagnetic data analysis.

For a better understanding of the present invention and in order to show how the same may be carried into effect, preferred embodiments of the invention will now be described, by way of example, with reference to the accompanying drawings in which:

FIG. 1 illustrates the environment and apparatus for the acquisition of EM-SBL data;

FIGS. 2a and 2b illustrate types of wave present in a typical EM-SBL environment;

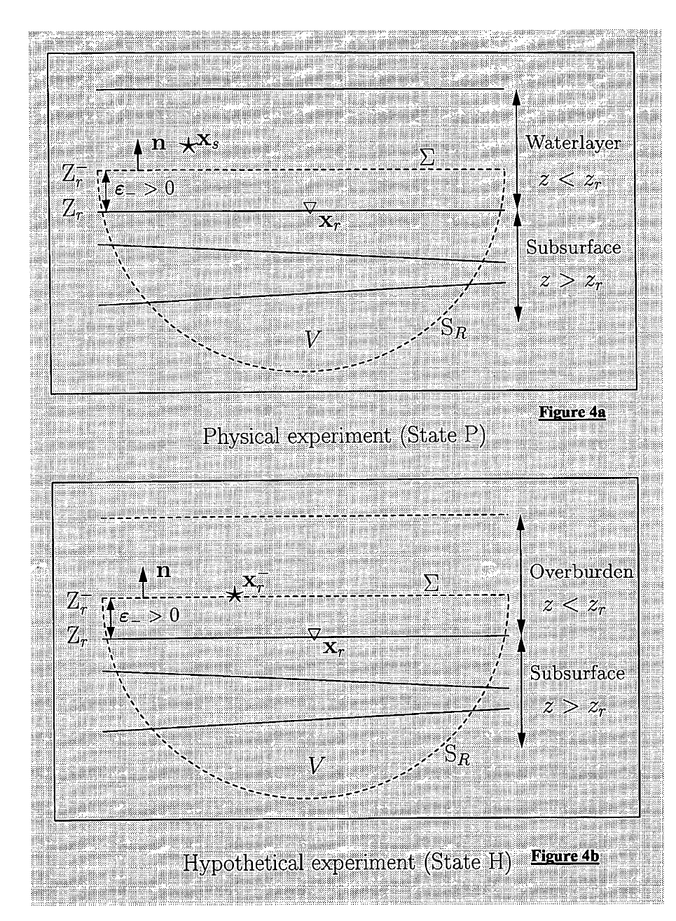

FIGS. 3a to 3c further illustrate the wave propagation present in a typical EM-SBL;

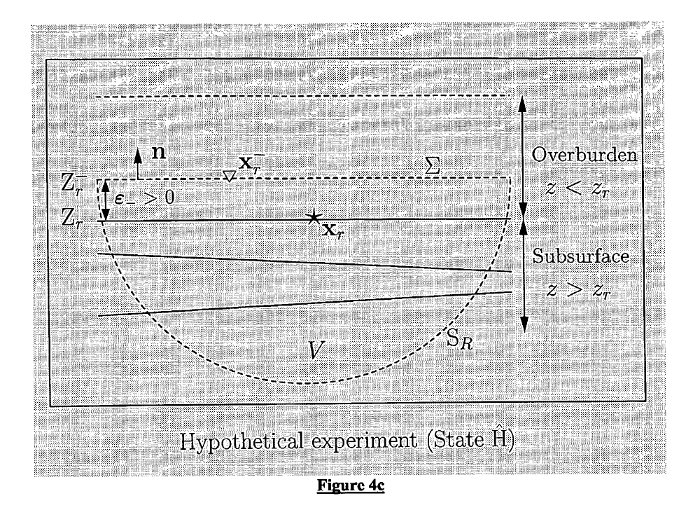

FIGS. 4a to 4c illustrate the geometry of the method of an embodiment of the present invention;

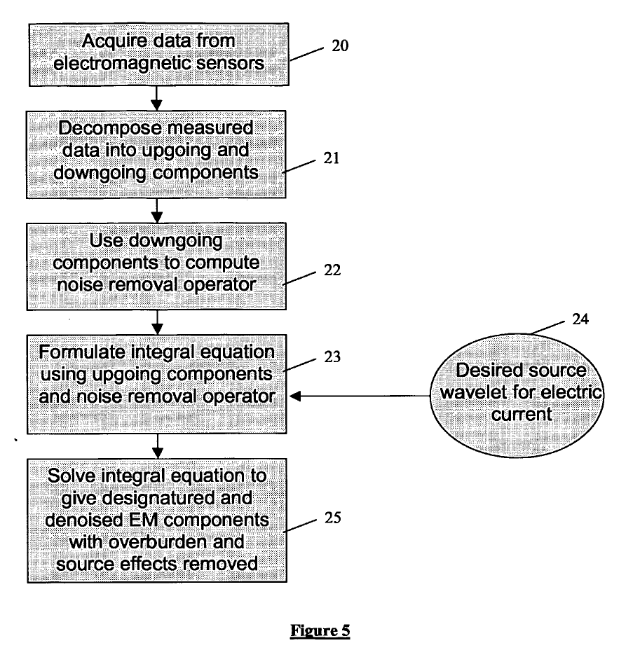

FIG. 5 is a flow diagram illustrating a method in accordance with an embodiment of the present invention; and

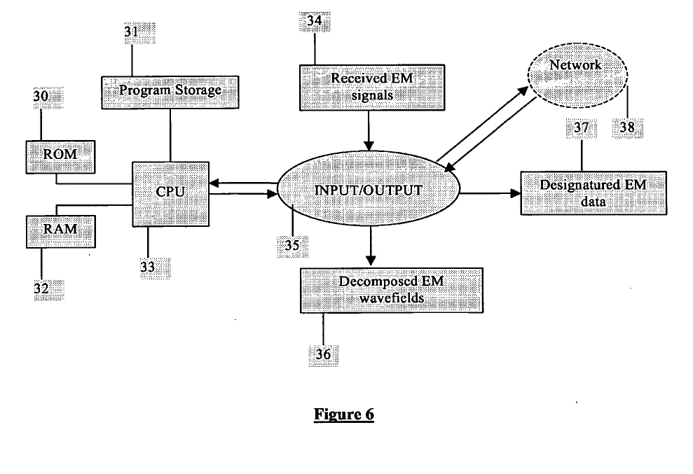

FIG. 6 is a block schematic diagram of an apparatus for performing the method of an embodiment of the present invention.

Optimal processing, analysis and interpretation of the electromagnetic data recorded at the receivers during a typical EM-SBL survey ideally requires full information about the field.

The electromagnetic field will obey Maxwell's equations. In order to solve Maxwell's equations, the behaviour of the electromagnetic field at material interfaces and boundaries in the earth must be specified. At material interfaces, the tangential electric and magnetic fields are continuous. Even though all three electric and three magnetic components may be recorded, it is sufficient to record the two tangential components of the electric field and the two tangential components of the magnetic field. The normal components of the electromagnetic field can be determined from Maxwell's equations when the tangential components are measured and the surrounding media properties are known.

FIG. 3a illustrates a multi-component source and multi-component receiver electromagnetic survey. The source 2 is a horizontal electric dipole that transmits a low-frequency electromagnetic signal down through the underlying rock formations. Using such a source, it is in principle possible to perform a two-component source survey where two orthogonal experiments are generated separately: one with the dipole antenna in the inline direction and a second with the dipole antennae arranged in the cross line direction. For each experiment, multicomponent electric and magnetic field sensors on a plane or along a line record the electromagnetic field. The source 2 emits electromagnetic waves with an amplitude which depends on the direction of propagation. Likewise, the receivers 3 record the electromagnetic waves with a sensitivity depending on the angle of incidence. The arrows and dots in FIGS. 3a to 3c indicate the orientation of the sources and receivers: in the horizontal plane and perpendicular to the plane, respectively. The first two wave diagrams of FIGS. 3a show a transverse magnetic source, and the third and fourth show a transverse electric source. Upgoing and downgoing waves are emitted from the source and the receivers measure both upgoing and downgoing waves without distinguishing.

A method of processing acquired or artificially generated electromagnetic data is described below which enables cancellation of the overburden effect. In electromagnetic recording such as EM-SBL, the overburden is the water layer above the receivers, including the seabed interface. The method described below requires no information about the medium above and below the receiver plane, except for the local electric permittivity, magnetic permeability and electric conductivity at the receiver. For EM-SBL data in particular, only information of the electric conductivity is required due to their low-frequency nature.

The method follows from the electromagnetic reciprocity theorem which provides an integral equation relationship between two independent electromagnetic fields defined in a specified volume enclosed by a hypothetical or physical surface. The relationship between the two fields is governed by possible differences in medium parameters, possible differences in source distributions, and possible differences in boundary conditions. The reciprocity theorem gives an integral equation procedure for transforming fields recorded in the physical electromagnetic experiment with the overburden response present into fields that would have been recorded in the hypothetical electromagnetic experiment with the overburden response absent. Mathematically, this follows from the reciprocity theorem by choosing outgoing boundary conditions for the desired field on the receiver plane.

The wave-equation method that eliminates the overburden response is described as Lorentz designature/denoise analysis. This method preserves primary amplitudes whilst eliminating all waves scattered from the overburden. It requires no knowledge of the medium below the reviever level or above the receiver level. In the case where the subsurface is anisotropic and horizontally layered, the Lorentz designature/denoise scheme can be simplified and implemented as a deterministic multicomponent source, multicomponent receiver, multidimensional deconvolution of common shot gathers. When the subsurface is isotropic and horizontally layered, the Lorentz designature/denoise de-couples on the source side into transverse electric and transverse magnetic problems, where a scalar field formulation of the multidimensional deconvolution is sufficient.

The method begins from the assumption that the source is located in a horizontal plane anywhere in the water column strictly above the receiver plane. Further, the receiver measurements must allow a field decomposition on the receiver side just below the seabed into upgoing and downgoing wave components. From the upgoing and downgoing waves at the receiver level, the reciprocity theorem is used to eliminate the water layer response. The recorded physical electromagnetic data can then be transformed to the desired data that would have been recorded in a hypothetical electromagnetic experiment without the water layer. The source in this hypothetical experiment is chosen to be a point source of electric current with some desired signature. A magnetic source may also be chosen and is an extension of the present invention that the skilled person would know to undertake. This situation is illustrated in FIG. 3b. Since the water layer is absent and the incident field due to the source is removed, there are no downgoing waves at the receiver. The effect of the physical source and its radiation characteristics have been removed. This may be considered as new data having been designatured and denoised by a multidimensional signature deconvolution process.

The Lorentz designature/denoise method, using data decomposed just below the seabed, replaces the water layer with a homogeneous half space with properties equivalent to those of the seabed. The designatured/denoised data will not contain the incident field. This data is highly useful for further processing and interpretation.

Alternatively, the data may be decomposed into upgoing and downgoing components just above the seabed. The situation is illustrated in FIG. 3c. In this case, the effect of the seabed is still present in the designatured/denoised data. The effect of the water column and sea surface have, however, been eliminated. Applying the Lorentz designature/denoise scheme just above the seabed is less preferable then applying it below the seabed because reflections and refractions from the incident field due to the point source will be present in the modified data. If application of the decomposition just above the seabed is the only possibility, a possible solution is to follow the designature/denoise processing with a further up-down field decomposition below the seabed.

The notation used in the remainder of the specification is set out below in Table 1. Bold face type is used to distinguish matrices and vectors from their components. The summation convention for repeated indices is used. Repeated Latin subscripts range over the values 1, 2 and 3 whilst repeated Greek subscripts take the values 1 and 2. The Kroenecker delta function is used

$${δ}_{ij} = \{ \begin{matrix}1 i = j \\ 0 i \neq j\end{matrix} ,$$

as is the Levi-Civita tensor, with components

εᵢⱼₖ=0, if any of ijk are equal

otherwise

ε₁₂₃=ε₃₁₂=ε₂₃₁=−ε₂₁₃=−ε₃₂₁=−ε₁₃₂=1.

TABLE 1

| | |
|---|---|
| A | system matrix, |
| B | electric-magnetic field vector, |
| c | complex velocity, c⁻² = μ\tilde{ε} = −ω⁻²ηζ, |
| e_{μ} | unit vector along the x_{μ} − direction |
| E = (E₁, E₂, E₃) | electric field, |
| E = (E₁, E₂) | horizontal electric field components, |
| = E^{(U)} + E^{(D)} | |
| E^{(U)} = (E₁^{(U)}, E₂^{(U)}) | upgoing components of horizontal |
| | electric field, |
| E^{(D)} = (E₁^{(D)}, E₂^{(D)}) | downgoing components of horizontal |
| | electric field, |
| F | 4 × 1 source vector, |
| G | 2 × 2 Green's tensor, |
| G | 2 × 2 Green's tensor for the special case |
| | when source and receiver depths are close, |
| | and lateral source coordinates are zero, χₛ = 0, |
| H = (H₁, H₂, H₃) | magnetic field, |
| H = (H₁, H₂) | horizontal magnetic field, |
| = (−H₂, H₁) | |
| H = H^{(U)} + H^{(D)} | |
| H^{(U)} = (−H₂^{(U)}, H₁^{(U)}) | upgoing components of horizontal |
| | magnetic field, |
| H^{(D)} = (−H₂^{(D)}, H₁^{(D)}) | downgoing components of horizontal |
| | magenetic field, |
| J | volume density of electric current, |
| K | volume density of magnetic current, |
| L, L⁻¹ | 4 × 4 composition/decomposition matrix, |
| L₁ | 2 × 2 submatrix of L, |
| n | unit vector normal to surface, |
| p = (p₁, p₂) = κ/ω, | horizontal slowness vector, radial slowness |
| p = \|p\| | |
| q, q₁, q₂ | vertical slowness, q = \sqrt{c⁻² − p₁² − p₂²}, |
| | q₁ = \sqrt{c⁻² − p₁²}, q₂ = \sqrt{c⁻² − p₂²} |
| R | reflectivity of subsurface |
| W = (E^{(U)}^{^{T}}, (E^{(U)}^{^{T}})^{T} | wave vector, |
| x = (x₁, x₂, x₃) | variables of Cartesian coordinate system, |
| χ = (x₁, x₂) | Cartesian horizontal coordinates, |
| δ(x) | Dirac delta function, |
| δᵢⱼ | Kroenecker delta function, |
| ∈ᵢⱼₖ | Levi-Civita tensor (the altering tensor), |
| κ = (k₁, k₂) = ωp | horizontal wavenumbers, |
| ω | circular frequency, |
| σ | electric conductivity, |
| μ | magnetic permeability, |
| ε | electric permittivity, |
| \tilde{ε} | complex electric permittivity, $\tilde{ɛ} = ɛ ( 1 + \frac{i σ}{ω ɛ} )$ |
| η | transverse admittance per length of the |
| | medium, η = σ − iωε = −iω\tilde{ε}, |
| ζ | longitudinal impedance per length of the |
| | medium, ζ = −iωμ, |
| ∂ᵢ | spatial derivative; ${\partial }_{i} = \frac{\partial }{\partial {x}_{i}} ,$ |
| ∇ | Gradient operator. |

The wavenumber, which characterizes the interaction of the EM field with the physical properties of the medium and frequency, can be written as

k=κ₊+iκ₋,

where

$${κ}_{\pm } = {ω ( \frac{ɛ μ}{2} [ {( 1 + \frac{{σ}^{2}}{{ω}^{2} {ɛ}^{2}} )}^{1 / 2} \pm 1 ] \}}^{1 / 2} .$$

The imaginary part of the wavenumber leads to the attenuation of a propagating EM wave in space. The wavenumber can also be expressed as:

k=ω(\tilde{ε}μ)^{1/2},

with complex permittivity \tilde{ε} defined by

$$\tilde{ɛ} = ɛ ( 1 + \frac{i σ}{ω ɛ} ) ,$$

so as to absorb the conductivity as its imaginary part. This allows a unified treatment of an EM wavefield in both conductive (σ≠0) and non-conductive (σ=0) media. For very high frequencies, ω>>σ/ε, the wavenumber is real and given as

k≈ω(εμ)^{1/2},

and its dependence on the electric conductivity is negligible. Conduction currents are much smaller than displacement currents and can be neglected. In this circumstance the EM field propagates as a wave without significant attenuation. The scalar Green's function associated with the EM field, obeying (∇²+k²)G=−4πδ(x−x′), has the well-known form

$$G = \frac{1}{R} exp ( i kR ) ,$$

where R=|x−x′|.

For very low frequencies, ω<<σ/ε, as in the EM-SBL experiment, and the field is said to be diffusive. The squared wavenumber is purely imaginary,

k²≈iωμσ,

and its dependence on electric permittivity is negligible. Displacement currents are much smaller than conduction currents and can be neglected. Setting i^{1/2}=(l+i)/\sqrt{2}, the wavenumber is written as:

k≈(l+i)κ,

with real component

$$κ = {κ}_{+} = {κ}_{-} = {( \frac{ω μ σ}{2} )}^{1 / 2} .$$

In this circumstance, the scalar Green's function associated with the EM field is

$$G = \frac{1}{R} exp ( i κ R ) exp ( - κ R ) .$$

Since κ is real the wave varies sinusoidally and is attenuated with distance. In one wavelength, the attenuation of the field is 2π.

For EM-SBL wavefield decomposition, the complex electric permittivity is independent of the electric permittivity, but depends on the electric conductivity as

$$\tilde{ɛ} = \frac{i σ}{ω} .$$

The magnetic permeability u is set to that of free-space (μ=μ₀=4π·10⁻⁷ H/m), which is representative of a non-magnetic water layer and seabed. The complex velocity is then

$$c = {( \frac{ω}{i {μ}_{0} σ} )}^{1 / 2} .$$

The phase velocity is given by cₚₕ=ω/Re(k), yielding

$${c}_{p h} = {( \frac{2 ω}{{μ}_{o} σ} )}^{1 / 2} .$$

Conductivity, measured in Siemens per metre, (or its reciprocal, resistivity) of sea water depends on salinity and temperature and typically is in the range σ˜1−5S/m. The salinity varies from sea to sea, but most major oceans have 3.5 percent weight. At zero degrees Celcius, the resistivity is approximately 0.34 Ωm, and the conductivity is 2.94S/m. Under these conditions and at a frequency of ¼ Hz the phase velocity in sea water is cₚₕ≈922 m/s. The skin depth δ, where the EM wave will be reduced in amplitude by a factor of 1/ε, is

$$δ = {( \frac{2}{ω {μ}_{0} σ} )}^{1 / 2} .$$

At a frequency of ¼ Hz the skin depth in the sea water example is δ≈586 m.

### Defining the Geometry for the Integral Equation

A volume V may be defined by the closed surface S=Σ+S_{R} with outward-pointing normal vector n, as illustrated in FIG. 4a. Σ is a horizontal plane surface located at depth zᵣ⁻ infinitesimally above the multi-component receivers located at depth level zᵣ. The Cartesian coordinate is denoted by x=(χ,X₃), where χ=(x₁,x₂ ). For notational convenience, x₃=z. The z-axis, which is positive downwards, is parallel to n. The x₁,x₂-axes are in the Σ plane. To simplify the analysis it is assumed that the medium is homogeneous and isotropic at depth zᵣ and in a infinitesimal region below. The overburden is the region for which z<z, and the subsurface is that for which z>zᵣ. Both may be arbitrarily inhomogeneous and anisotropic. S_{R} is a hemisphere of radius R.

In an EM-SBL survey, recording takes place on the sea bed. Due to continuity of the horizontal components of the EM field across the sea bed, the receivers may be assumed to be just below the sea bed. In this case, Σ coincides with the sea bed, and the overburden is the water layer, including the sea bed. Further below, the case in which the receivers sit just above the sea bed will be considered.

An integral relationship between the multi-component source and the multi-component receiver data in the physical EM experiment will now be derived, containing the scattering response of the water layer above the receivers and the desired multi-component source, multi-component receiver data with that scattering response attenuated. The physical source is assumed to separately generate two orthogonal electric currents along the horizontal axes of the Cartesian coordinate system. The desired multi-component data are those data that would be recorded in a hypothetical multi-component EM experiment from two orthogonally oriented sources of electric current acting separately with equal signatures when the medium above the receivers is homogeneous, extending upwards to infinity, with parameters equal to those at the receiver depth level (i.e. the sea bed). Magnetic point sources may also be used, but are not discussed further here. The overburden is therefore an isotropic halfspace. The geology below the receiver level is the same in the physical and hypothetical EM experiments.

The physical EM experiment has a configuration as illustrated in FIG. 4a. The recorded μ^{th} component of the electric field vector at receiver location xᵣ, just below Σ, due to a source oriented in direction v at center coordinate x, with unknown source strength and radiation pattern is denoted by E_{μv}. Likewise, the μ^{th} component of the magnetic vector is denoted by H_{μv}. The source and field variables for the physical EM experiment, denoted as “state P”, are listed in Table 2 below.

The desired wavefields, \tilde{E}_{μv} and \tilde{H}_{μv}, that it is proposed to solve for are the responses of the medium from two orthogonally oriented sources of electric current with desired signature or wavelet \tilde{α} corresponding to the dipole moment when the medium above the receiver level is a halfspace with properties equal to those of the sea bed as illustrated in FIG. 4b. Σ is a non-physical boundary. The desired electric and magnetic vector responses are recorded at location x, just below Σ for the point sources located at xᵣ⁻ on Σ. The source and field variables for this hypothetical EM experiment denoted as “state H” are listed in Table 2 below.

To establish the integral relationship between the physical state P and hypothetical state H, the hypothetical “state H” is introduced, with wavefields Ê_{vμ} and Ĥ_{vμ} being the reciprocal wavefields to the ones in state H, obeying the reciprocity relation

Ê_{vμ}(xᵣ⁻|xᵣ)=\tilde{E}_{μv}(xᵣ|xᵣ⁻),

Ĥ_{vμ}(xᵣ⁻|xᵣ)=\tilde{H}_{μv}(xᵣ|xᵣ⁻).

Thus, Ê_{vμ} and Ĥ_{vμ} are responses at location xᵣ⁻ on surface Σ due to a point source of electric current, with signature \tilde{α}, oriented in direction μ at location xᵣ just below Σ as illustrated in FIG. 4c. Surface Σ is, in the desired state H, an artificial, non-physical boundary. The source and field variables for state Ĥ are listed in Table 2 below.

TABLE 2

| | State P | State H | State Ĥ |
|---|---|---|---|
| Electric | a(x\|xₛ)e_{ν} | ãδ(x − xᵣ⁻)e_{ν} | ãδ(x − xᵣ)e_{μ} |
| Current | | | |
| Magnetic | 0 | 0 | 0 |
| current | | | |
| Electric field | E_{μν}(xᵣ\|xₛ) | \tilde{E}_{μν}(xᵣ\|xᵣ⁻) | Ê_{νμ}(xᵣ⁻\|xᵣ) |
| Magnetic field | H_{μν}(xᵣ\|xₛ) | \tilde{H}_{μν}(xᵣ\|xᵣ⁻) | Ĥ_{νμ}(xᵣ⁻\|xᵣ) |

### Reciprocity Theorem

Reciprocity is an important property of wavefields. The reciprocity principle for elastostatic fields was derived by Betti and extended by Rayleigh to acoustic fields. In EM wave theory, reciprocity was introduced by Lorentz. The electromagnetic reciprocity theorem gives an integral equation relationship between two independent electromagnetic wavefields defined in a volume V enclosed by a surface S. The relationship between the two wavefields is governed by possible differences in medium parameters, possible differences in source distributions, and possible differences in external boundary conditions on S.

Maxwell's equations for electromagnetic wave motion in an inhomogeneous medium can be expressed as:

∇×H(x,ω)−η(x,ω)E(x,ω)=J(x,ω),

∇×E(x,ω)+ζ(x,ω)H(x,ω)=K(x,ω).

In a domain or volume V enclosed by the surface S with outward pointing normal vector n, two non-identical electromagnetic fields denoted by the fields for “state A” and “state B”, respectively may be defined. The boundary conditions for the fields are not yet specified. State A is defined as

∇×H^{A}−η^{A}E^{A}=J^{A},

∇×E^{A}+ζ^{A}H^{A}=K^{A},

and state B is given as

∇×H^{B}−η^{B}E^{B}=J^{B},

∇×E^{B}+ζ^{B}H^{B}=K^{B}.

It is well known that by inserting special vectors, here denoted by Q, into Gauss' theorem,

$${\int }_{V}^{ } d V ∇ \cdot Q = {∮}_{s} d Sn \cdot Q ,$$

different Green's vector theorems that are useful for studying wave propagation problems can be obtained. For EM waves, the specific choice

Q=E^{A}×H^{B}−E^{B}×H^{A}

is useful. Applying standard rules of vector calculus to ∇·Q, yields the simple expression

$$\begin{matrix}∇ \cdot Q = {H}^{B} ( ∇ \times {E}^{A} ) - {E}^{A} \cdot ( ∇ \times {H}^{B} ) - \\ {H}^{A} \cdot ( ∇ \times {E}^{B} ) + {E}^{B} \cdot ( ∇ \times {H}^{A} ) \\ = {K}^{A} \cdot {H}^{B} - {K}^{B} \cdot {H}^{A} + {J}^{A} \cdot {E}^{B} - {J}^{B} \cdot {E}^{A} - \\ ( {ζ}^{A} - {ζ}^{B} ) {H}^{A} \cdot {H}^{B} + ( {η}^{A} - {η}^{B} ) {E}^{A} \cdot {E}^{B} .\end{matrix}$$

Inserting this into Gauss' theorem leads to

$${∮}_{s} d Sn \cdot [ {E}^{A} \times {H}^{B} - {E}^{B} \times {H}^{A} ] = {\int }_{V}^{ } d V [ {K}^{A} \cdot {H}^{B} - {K}^{B} \cdot {H}^{A} + {J}^{A} \cdot {E}^{B} - {J}^{B} \cdot {E}^{A} - ( {ζ}^{A} - {ζ}^{B} ) {H}^{A} \cdot {H}^{B} + ( {η}^{A} - {η}^{B} ) {E}^{A} \cdot {E}^{B} ] . \qquad [ 1 ]$$

Equation 1 is Green's vector theorem. It is also known as the reciprocity theorem, or integral representation, or integral equation for EM waves. The reciprocity theorem gives the relationship between two vector wavefield variables which characterize two states that could occur in the same domain or volume V. Each of the states may be associated with its own medium parameters and its own distribution of sources. On the right-hand side of Equation 1, the four first terms represent the action of possible sources in V. The two last terms under the volume integral represent possible differences in the EM properties of the media present in the two states. On the left-hand side of Equation 1, the surface integral takes into account possible differences in external boundary conditions.

Reciprocity Between State P and State Ĥ

The physical (state P) and hypothetical (state Ĥ) EM experiments are described above and depicted in FIGS. 4a and 4c with volume V and enclosing surface S=Σ+S_{R}. Refering to the discussion of the previous section, state A is identified with state P (FIG. 4a), and state B with state Ĥ (FIG. 4c). In both states, Σ is a plane surface infinitesimally above the receiver plane, and S_{R} is a hemisphere of radius R. The field variables and sources for these states are defined in Table 2 above; thus giving in volume V for state A=P:

E^{A}=Eᵥ(x,ω),

H^{A}=Hᵥ(x,ω),

ζ^{A}=ζ(x,ω),

η^{A}=η(x,ω),

K^{A}=0,

J^{A}=0.

The source term is zero since the source, assumed to be a source of electric current oriented in direction v at center location xₛ, is outside V. Further, identify state B=Ĥ, so that in volume V:

E^{B}=Ê_{μ}(x,ω),

H^{B}=Ĥ_{μ}(x,ω),

ζ^{B}=ζ(x,ω),

η^{B}=η(x,ω),

K^{B}=0,

J^{B}(x)=\tilde{α}δ(x−xᵣ)ê_{μ}.

The fields are generated from a point source of electric current oriented in direction μ, located at position x, infinitesimally below surface Σ. Inserting the above expressions into the reciprocity theorem yields

\hat{α}Eᵥ·ê_{μ}= [symbol] ₛdSn·(Ĥ_{μ}×Eᵥ+Ê_{μ}×Hᵥ).

Letting the radius R go to infinity, the surface S_{R}→∞ gives zero contribution to the surface integral. This is the Silver-Müller radiation condition. Furthermore, taking into account that the surface Σ is horizontally plane such that nᵢ=−δᵢ₃ and using that

(C×D)ᵢ=εᵢⱼₖCⱼDₖ

gives

\tilde{α}E_{μv}=−∫_{μ}dSε₃ⱼₖ(Ĥ_{jμ}Eₖᵥ+Ê_{jμ}Hₖᵥ).

Using the properties of the Levi-Civita tensor εᵢⱼₖ, gives

\tilde{α}E_{μv}=−∫_{Σ}dS(Ĥ_{1μ}E₂ᵥ−Ĥ_{2μ}E₁ᵥ+Ê_{1μ}H₂ᵥ−Ê_{2μ}H₁ᵥ).

Introducing the magnetic components H₁ =−H₂ and H₂=H₁ in the above equation, the summation convention readily applies. This then gives:

\tilde{α}E_{μv}(xᵣ|xₛ)=∫_{Σ}dS(X)[Ĥ_{αμ}(x|xᵣ)E_{αv}(x|xₛ)−Ê_{αμ}(x|xᵣ)H_{αv}(x|xₛ)]

Equation 2 is the starting point for deriving the Lorentz designature/denoise scheme and describes the relationship between state P and state Ĥ and can be simplified by identifying proper boundary conditions for the fields on Σ. In the physical state P, E_{αv} and H_{αv} are sums of upgoing and downgoing waves:

E_{αv=}E_{αv}^{(U)}+E_{αv}^{(D)}, [3]

H_{αv}=H_{αv}^{(U)}+H_{αv}^{(D)}. [4]

The physical fields, or equivalently, their upgoing and downgoing components, contain all information on the water layer overburden, including the effect of all physical sources. On the other hand, the data in the hypothetical state Ĥ experiment consist of upgoing events only, scattered from the subsurface below Σ. In addition, the direct wavemodes from the sources to the receivers are upgoing events since the sources are below the receivers. Thus in the hypothetical state Ĥ,Ê_{αμ} and Ĥ_{αμ} are purely upgoing fields:

Ê_{αμ}=Ê_{αμ}^{(U)}; Ê_{αμ}^{(D)}=0, [5]

Ĥ_{αμ}=Ĥ_{αμ}^{(U)};Ĥ_{αμ}^{(D)}=0 [6]

Mathematically, to require outgoing (upgoing) boundary conditions on Σ for the fields of state Ĥ is equivalent to require the medium above Σ to be homogeneous. The boundary conditions of Equation 3 to 6 are most conveniently introduced into Equation 2 by analysing the problem in the horizontal wavenumber domain, where upgoing and downgoing waves and their relation to electric and magnetic field vectors are analytically known.

### Relationships in the Wavenumber Domain

A homogeneous isotropic region of the earth is now considered. Maxwell's equations can be written as a system of first-order ordinary differential equations of the form

∂₃B=iωAB+F,

where the EM field vector B is a 4×1 column vector

B=(E^{T},H^{T})^{T}

and the electric E=(E₁,E₂)^{T} and magnetic H=(−H₂,H₁)^{T} field vectors are 2×1 column vectors. The 4×4 system matrix A is partitioned into four 2×2 submatrices of which the diagonal ones are zero,

$$A = [ \begin{matrix}0 & {A}_{1} \\ {A}_{2} & 0\end{matrix} ]$$

The symmetric submatrices A₁ and A₂,

$${A}_{1} = - {\tilde{ɛ}}^{- 1} [ \begin{matrix}{q}_{1}^{2} & - {p}_{1} {p}_{2} \\ - {p}_{1} {p}_{2} & {q}_{2}^{2}\end{matrix} ] ;$$

$${A}_{2} = - {μ}^{- 1} [ \begin{matrix}{q}_{2}^{2} & {p}_{1} {p}_{2} \\ {p}_{1} {p}_{2} & {q}_{1}^{2}\end{matrix} ] ,$$

are functions of the parameters in Maxwell's equations and of horizontal slowness P_{μ}. When the source of magnetic current is zero (K=0), the source vector F is

$$F = [ \begin{matrix}{F}_{1} \\ {F}_{2}\end{matrix} ] , \\ where$$

$${F}_{1} = [ \begin{matrix}{\tilde{ɛ}}^{- 1} {p}_{1} {J}_{3} \\ {\tilde{ɛ}}^{- 1} {p}_{2} {J}_{3}\end{matrix} ] ; {F}_{2} = [ \begin{matrix}{J}_{1} \\ {J}_{2}\end{matrix} ]$$

For notational convenience, the explicit dependence of different quantities on frequency, wavenumber, depth, etc., is omitted. For instance, the electric field vector E(X,x₃,ω;Xₛ) recorded at depth x₃ due to a point source at location xₛ is in the wavenumber domain denoted E or E(x₃) with the understanding E=E(x₃)=E(k,X₃,ω;Xₛ).

Both the electric and magnetic field consist of waves travelling upwards (U) and waves travelling downwards (D). The electric and magnetic fields can then be expressed as:

E=E^{(U)}+E^{(D)}

and

H=H^{(U)}+H^{(D)}.

The field vector B is decomposed into upgoing and downgoing waves of the electric field as

w=[E^{(U)}^{^{T}},E^{(D)}^{^{T}}]^{T},

by the linear tranformation

B=LW, [7]

where L is the local eigenvector matrix of A (i.e., each column of L is an eigenvector). Equation 7 describes composition of the wavefield B from its upgoing and downgoing constituents. Given the inverse eigenvector matrix L⁻¹, the up-and donwgoing waves can be computed by evaluating

W=L⁻¹B.

This describes decomposition of the wavefield B into upgoing and downgoing waves of the electric field.

The composition matrix

$$L = [ \begin{matrix}I & I \\ {L}_{1} & - {L}_{1}\end{matrix} ] \qquad [ 8 ]$$

with inverse, the decomposition matrix,

$${L}^{- 1} = \frac{1}{2} [ \begin{matrix}I & {L}_{1}^{- 1} \\ I & - {L}_{1}^{- 1}\end{matrix} ] ,$$

can be derived, where I is the 2×2 identity matrix, and

$${L}_{1} = \frac{1}{μ q} ( \begin{matrix}{q}_{2}^{2} & {p}_{1} {p}_{2} \\ {p}_{1} {p}_{2} & {q}_{1}^{2}\end{matrix} ) .$$

From Equation 7 and 8 it can be established that

H=L₁(E^{(U)}−E^{(D)}).

From W=L⁻¹B and the decomposition matrix L⁻¹, the upgoing and downgoing electric-field components can be written as

$$\begin{matrix}{E}^{( U )} = \frac{1}{2} ( E + {L}_{1}^{- 1} H ) , \\ {E}^{( D )} = \frac{1}{2} ( E - {L}_{1}^{- 1} H ) .\end{matrix}$$

Similarly for the magnetic field:

$$\begin{matrix}{H}^{( U )} = {L}_{1} {E}^{( U )} = \frac{1}{2} ( H + {L}_{1} E ) , \\ {H}^{( D )} = - {L}_{1} {E}^{( D )} = \frac{1}{2} ( H - {L}_{1} E ) .\end{matrix}$$

In component form, the downgoing constituents are:

$$\begin{matrix}{E}_{1}^{( D )} = \frac{1}{2} [ {E}_{1} + \frac{1}{\tilde{ɛ} q} ( {p}_{1} {p}_{2} {H}_{1} + {q}_{1}^{2} {H}_{2} ) ] , \\ {E}_{2}^{( D )} = \frac{1}{2} [ {E}_{1} + \frac{1}{\tilde{ɛ} q} ( {p}_{1} {p}_{2} {H}_{2} + {q}_{2}^{2} {H}_{1} ) ] , \\ {H}_{1}^{( D )} = \frac{1}{2} [ {H}_{1} - \frac{1}{μ q} ( {p}_{1} {p}_{2} {E}_{1} + {q}_{1}^{2} {E}_{2} ) ] , \\ {H}_{2}^{( D )} = \frac{1}{2} [ {H}_{2} - \frac{1}{μ q} ( {p}_{1} {p}_{2} {E}_{2} + {q}_{2}^{2} {E}_{1} ) ] .\end{matrix}$$

The corresponding upgoing constituents are:

E_{μ}^{(U)}=E_{μ}−E_{μ}^{(D)},

H_{μ}^{(U)}=H_{μ}−H_{μ}^{(D)}.

In a source-free homogeneous isotropic medium upgoing and downgoing waves satisfy the differential equations

∂₃E^{(U)}=−iωqE^{(U)},

∂₃H^{(U)}=−iωqH^{(U)},

∂₃E^{(D)}=iωqE^{(D)},

∂₃H^{(D)}=iωq H^{(D)},.

Making use of Parsevals' identity, Equation 2 yields:

$$\begin{matrix}\tilde{α} {E}_{μ ν} ( {x}_{r} \vert {x}_{s} ) = \frac{1}{{( 2 π )}^{2}} {\int }_{- ∞}^{∞} d κ [ {\hat{H}}_{α μ} ( κ , {z}_{r}^{-} \vert {x}_{r} ) {E}_{α v} ( - κ , {z}_{r}^{-} \vert {x}_{s} ) - \\ {\hat{E}}_{α μ} ( κ , {z}_{r}^{-} \vert {x}_{r} ) {H}_{α ν} ( - κ , {z}_{r}^{-} \vert {x}_{s} ) ] .\end{matrix}$$

Introducing vector notation instead of using the summation convention, this can be written as:

$$\begin{matrix}\tilde{α} {E}_{μ ν} ( {x}_{r} \vert {x}_{s} ) = \frac{1}{{( 2 π )}^{2}} {\int }_{- ∞}^{∞} d κ [ {\hat{H}}_{μ}^{T} ( κ , {z}_{r}^{-} \vert {x}_{r} ) {E}_{v} ( - κ , {z}_{r}^{-} \vert {x}_{s} ) - \\ {\hat{E}}_{μ}^{T} ( κ , {z}_{r}^{-} \vert {x}_{r} ) {H}_{v} ( - κ , {z}_{r}^{-} \vert {x}_{s} ) ] ,\end{matrix}$$

where H^{T}=(H₁, H₂)=(−H₂,H₁) and pyf E^{T}=(E₁,E₂) are the wavenumber domain magnetic field vector and electric field vector, respectively, and the superscript ^{T} denotes transpose. As detailed above, since the hypothetical state Ĥ fields Ĥ and Ê consist of upgoing wave modes only, they are related as

Ĥ(κ)=L₁(κ)Ê(κ),

where L₁, defined above as

$${L}_{1} = \frac{1}{μ q} ( \begin{matrix}{q}_{2}^{2} & {p}_{1} {p}_{2} \\ {p}_{1} {p}_{2} & {q}_{1}^{2}\end{matrix} ) ,$$

is a 2×2 matrix depending on the local medium parameters along the receiver spread. The matrix L₁ obeys the symmetry relation

L₁(κ)=L₁^{T}(κ)=L₁(−κ).

E^{(U)} and E^{(D)} are upgoing and downgoing horizontal components of the electric field E respectively, such that

E=E^{(U)}+E^{(D)}.

The physical state P fields H and E then are related as

H(κ)=L₁(κ)[E^{(U)}(κ)−E^{(D)}(κ)]. [11]

Inserting Equations 9, 10 and 11 into Parseval's identity, the upgoing waves E^{(U)} cancel, so that

$$\tilde{a} {E}_{μ v} ( {x}_{r} \vert {x}_{s} ) = \frac{1}{{( 2 π )}^{2}} {\int }_{- ∞}^{∞} d κ {\hat{E}}_{m}^{T} ( κ , {z}_{r}^{-} \vert {x}_{r} ) {G}^{- 1} ( κ ) {E}_{n}^{( D )} ( - κ , {z}_{r}^{-} \vert {x}_{s} ) , \qquad [ 12 ]$$

where the 2×2 matrix

G=2L₁

is interpreted as the inverse of the Green's tensor in a homogeneous medium when the source and receiver depths are infinitesimally close. Inverting this gives the Green's tensor

$$G = \frac{1}{2} {L}^{- 1} = \frac{1}{2 \tilde{ɛ} q} ( \begin{matrix}{q}_{1}^{2} & - {p}_{1} {p}_{2} \\ - {p}_{1} {p}_{2} & {q}_{2}^{2}\end{matrix} ) .$$

Furthermore, the vector

E^{(D)}=[E₁^{(D)},E₂^{(D)}]^{T}

contains the elements of the downgoing wavemodes on each of the electric components E₁ and E₂. Generally, for every shot location, E^{(D)} may be calculated in the slowness (or wavenumber) domain from the electric and magnetic field vectors according to the downgoing components provided above and repeated here for convenience:

$$\begin{matrix}{E}_{1}^{( D )} = \frac{1}{2} [ {E}_{1} + \frac{1}{\tilde{ɛ} q} ( {p}_{1} {p}_{2} {H}_{1} + {q}_{1}^{2} {H}_{2} ) ] , \\ {E}_{2}^{( D )} = \frac{1}{2} [ {E}_{2} + \frac{1}{\tilde{ɛ} q} ( {p}_{1} {p}_{2} {H}_{2} + {q}_{2}^{2} {H}_{1} ) ] .\end{matrix}$$

The scalars in front of the electric and magnetic field components are called decomposition scalars. The upgoing constituents are

E_{μ}^{(U)}=E_{μ}−E_{μ}^{(D)}.

### Eliminating the Incident Wavefield of the Hypothetical State

The desired field Ê_{vμ} of the hypothetical experiment can be split into an incident wave field Ê_{vμ}^{(inc)} propagating upwards from the source to the receiver, and the wavefield Ê_{vμ}^{(sc)} scattered upwards from the subsurface,

Ê_{vμ}=Ê_{vμ}^{(inc)}+Ê_{vμ}^{(sc)}.

In vector notation, the incident wave field, which propagates in a homogeneous medium, is the wavelet \tilde{α} a multiplied by the Green's tensor G, that is,

Ê^{(inc)}(κ,z,ᵣ⁻|Xᵣ,zᵣ)=ãg(κ,zᵣ⁻|Xᵣ,zᵣ)=ãg(κ)exp(−iκ·χᵣ).

It can be further shown that:

$$\begin{matrix}{\hat{E}}^{{( inc )}^{τ}} ( κ , {z}_{r}^{-} \vert {x}_{r} ) {G}^{- 1} ( κ ) {E}^{( D )} ( - κ , {z}_{r}^{-} \vert {x}_{s} ) = \tilde{α } {G}^{T} ( κ ) {{G}^{- 1} ( κ )}^{{E}^{( D )}} \\ ( - κ , {z}_{r}^{-} \vert {x}_{s} ) exp ( - i κ \cdot {χ}_{r} ) \\ \tilde{a} {E}^{( D )} ( - κ , {z}_{r}^{-} \vert {x}_{s} ) exp ( - i κ \cdot {χ}_{r} ) .\end{matrix}$$

In Equation 12, on the left hand side the electric field can be split into upgoing and downgoing constituents and on the right hand side the hypothetical state electric field can be split into incident and scattered components. By identifying

$${E}_{μ ν }^{( D )} ( {x}_{r} \vert {x}_{s} ) = \frac{1}{{( 2 π )}^{2}} {\int }_{- ∞}^{∞} d κ exp ( - i κ \cdot {χ}_{r} ) {E}_{μ ν}^{( D )} ( - κ , {z}_{r} \vert {x}_{s} ) ,$$

it can be seen that the downgoing part of the electric field cancels from the left side of Equation 12, yielding

$$\tilde{a} {E}_{μ v}^{( U )} ( {x}_{r} \vert {x}_{s} ) = \frac{1}{{( 2 π )}^{2}} {\int }_{- ∞}^{∞} d κ {\hat{E}}_{μ}^{{( sc )}^{τ}} ( κ , {z}_{r}^{-} \vert {x}_{r} ) {G}^{- 1} ( κ ) {E}_{v}^{( D )} ( - κ , {z}_{r} \vert {x}_{s} ) ,$$

Using the reciprocity relation gives

$$\tilde{a} {E}_{μ v}^{( U )} ( {x}_{r} \vert {x}_{s} ) = \frac{1}{( 2 {π\_}^{2}} {\int }_{- ∞}^{∞} d κ {{\tilde{E}}_{μ α }^{( sc )} ( {x}_{r} \vert κ , {z}_{r}^{-} ) [ {G}^{1} ( κ ) ]}_{α β} {E}_{β v}^{( D )} ( - κ , {z}_{r}^{-} \vert {x}_{s} ) \\ {E}_{μ v}^{( U )} ( {x}_{r} \vert {x}_{s} ) = \frac{1}{{( 2 π )}^{2}} {\int }_{- ∞}^{∞} d κ {ZR}_{μ α} ( {x}_{r} \vert κ , {z}_{r}^{-} ) {E}_{α v}^{( D )} ( - κ , {z}_{r}^{-} \vert {x}_{s} ) \qquad [ 13 ]$$

Using the property of the Green's tensor, G^{(U)}(κ,zᵣ|zᵣ⁻)=G^{(D)}(κ,zᵣ⁻|zᵣ), implying that \tilde{E}^{(inc)}(κ,zᵣ\zᵣ⁻)=Ê^{(inc)}(κ,zᵣ⁻\zᵣ), gives

R=\tilde{E}^{(sc)}\tilde{E}^{(inc)}^{^{−1}},

which can be interpreted as the “reflectivity” of the subsurface in the absence of any overburden. Given as linear combinations of E_{μ1}^{(sc)} and E_{μ2}^{(sc)}, the elements of the reflection response are

$${R}_{μ 1} = \frac{2}{μ q} ( {q}_{2}^{2} {E}_{μ 1}^{( sc )} + {p}_{1} {p}_{2} {E}_{μ 2}^{( sc )} ) , \\ {R}_{μ 2} = \frac{2}{μ q} ( {p}_{1} {p}_{2} {E}_{μ 1}^{( sc )} + {q}_{1}^{2} {E}_{μ 2}^{( sc )} ) .$$

Finally, using Parseval's identity, Equation 13 reads in the space domain

E_{μv}^{(U)}(Xᵣ|xₛ)=∫_{Σ}dS(χ_{μα}(xᵣ|x)E_{αv}^{(D)}(x|xₛ), [14]

where r_{μα} is the inverse Fourier transform of R_{μα}. Equation 14 gives the sought-after integral relationship between the scattered field \tilde{E}_{μv}^{(sc)} (included in r_{μv}) in the hypothetical state H experiment and the state P total upgoing and downgoing fields E_{μv}^{(U)} and E_{μv}^{(D)}. Thus, from the upgoing and downgoing wavefields, the reciprocity theorem has provided the theoretical basis for eliminating the physical response of the medium above the receiver plane (water layer overburden) in the multi-component source, multi-component receiver EM experiment.

Other than the position of the orthogonally oriented source elements, no source characteristics are required to eliminate all EM waves scattered from the overburden. Whatever the physical source characteristic is, it will be cancelled when solving for E_{μv}^{(sc)} (or r_{μv}) as this characteristic is present both at the left and right sides of Equation 14 through the upgoing and downgoing fields. The multi-component sources have been transformed into point sources of electric current with the same frequency as that of the physical source. This wave-equation method to eliminate the physical source radiation characteristics and waves scattered from the water layer overburden is denoted by Lorentz designature/denoise as the reciprocity theorem is originally credited to Lorentz.

Equation 14 is a Fredholm integral equation of the first kind for the desired scattered fields, leading to a system of equations that can be solved for r_{μv} by keeping the receiver coordinate fixed while varying the source coordinate. Equation 14 can be compactly written as a matrix equation:

\tilde{E}^{(U)}(xᵣ|xₛ)=∫_{Σ}dS(x)r(xᵣ|x)E^{(D)}(x|xₛ).

\tilde{E}^{(sc)} is found from the reflectivity r by multiplying in the wavenumber domain the relectivity R by the incident wavefield:

\tilde{E}^{(sc)}=R·\tilde{E}^{(inc)}.

### Wavenumber Domain Solution

Fourier transforming Equation 13 over source coordinates χ, and receiver coordinates χ, yields the Lorentz designature/denoise procedure

$${E}_{μ v}^{( U )} ( {κ}_{r} , {z}_{r} \vert {κ}_{s} , {z}_{s} ) = \frac{1}{{( 2 π )}^{2}} {\int }_{- ∞}^{∞} d κ {R}_{μ α} ( {κ}_{r} , {z}_{r} \vert κ , {z}_{r}^{-} ) {E}_{av}^{( D )} ( - κ , {z}_{r}^{-} \vert {κ}_{s} , {z}_{s} ) .$$

The leads to a system of equations that can be solved for R_{μα} and \tilde{E}_{μα}^{(sc)} by keeping the wavenumber conjugate to the receiver coordinate fixed while varying the wavenumber conjugate to the source coordinate. The coupling between the positive wavenumbers in the downgoing overburden response field with negative wavenumbers in the desired field (and vice versa) reflects the autocorrelation process between the two fields. In matrix form, the Lorentz designature/denoise process can be written as:

$${E}^{( U )} ( {κ}_{r} , {z}_{r} \vert {κ}_{s} , {z}_{s} ) = \frac{1}{{( 2 π )}^{2}} {\int }_{- ∞}^{∞} d κ R ( {κ}_{r} , {z}_{r} \vert κ , {z}_{r}^{-} ) {E}^{( D )} ( - κ , {z}_{r}^{-} \vert {κ}_{s} , {z}_{s} ) .$$

### Lorentz Deconvolution: Horizontally Layered 1D Medium

An example of application of this method to a horizontally layered 1D medium, constituting an embodiment of the invention, will now be described. For a horizontally layered medium, the response is dependent only on the horizontal distance between the source and receiver, that is E_{αβ}(xᵣ|x)=E_{αβ}(χᵣ+χ_{z},zᵣ|χ+χₓ,z) where χ_{z} is an arbitrary horizontal vector. The shift variance implies that r_{αβ}(xᵣ|x)=r_{αβ}(χᵣ+χₛ−χ,zᵣ|χₛ,z). Equation 14 therefore can be written as

E_{μv}^{(U)}(Xᵣ|Xₛ)=∫_{Σ}dS(χ)r_{μα}(χᵣ+χₛ−χ,zᵣ|χₛ,z)E_{αv}^{(D)}(χ,z|xₛ).

Making use of a variant of Parsval's identity yields

$${E}_{μ v}^{( U )} = ( {x}_{r} \vert {x}_{s} ) = \frac{1}{{( 2 π )}^{2}} {\int }_{- ∞}^{∞} d κ {R}_{μ α} ( κ , {z}_{r} \vert {χ}_{s} , {z}_{r}^{-} ) {E}_{α v}^{( D )} ( κ , {z}_{r}^{-} \vert {x}_{s} ) exp [ i κ \cdot ( {χ}_{r} + {χ}_{s} ) ] .$$

Fourier transforming with respect to χᵣ and interchanging integrals gives

$${E}_{μ v}^{( U )} = ( {κ}_{r} , {z}_{r} \vert {x}_{s} ) = {\int }_{- ∞}^{∞} d κ {R}_{μ α} ( κ , {z}_{r} \vert {χ}_{s} , {z}_{r}^{-} ) {E}_{α v}^{( D )} ( κ , {z}_{r}^{-} \vert {x}_{s} ) exp ( i κ \cdot {χ}_{s} ) \frac{1}{{( 2 π )}^{2}} {\int }_{- ∞}^{∞} d {χ}_{r} exp [ i {χ}_{r} \cdot ( κ - {κ}_{r} ) ] .$$

The last integral may be recognized as the Dirac delta function δ(κ−κᵣ). Performing the integration over wavenumbers, using the Dirac delta function property

$${\int }_{- ∞}^{∞} d κ F ( κ ) δ ( κ - {κ}_{r} ) = F ( {κ}_{r} ) ,$$

where F(κ) is any continuous function of κ, and renaming κᵣ by κ, gives

E_{μv}^{(U)}(κ,zᵣ|xₛ)=R_{μα}(κ,zᵣ|χₛ,zᵣ⁻)E_{αv}^{(D)}(κ,zᵣ⁻|xₛ)exp(iκ·Lₛ).

This can be written in terms of matrices as

E^{(U)}(κ,zᵣ|xₛ)=R(κ,zᵣ|xₛ,zᵣ⁻)E^{(D)}(κ,zᵣ⁻|xₛ)exp(iκ·χₛ).

Inserting the expression for the reflectivity R (below Equation 13) gives

E^{(U)}(κ,zᵣ|xₛ)=\tilde{E}^{(sc)}(κ,zᵣ|χₛ,zᵣ⁻)\tilde{E}^{(inc)}^{^{−1}}(κ,zᵣ|zᵣ⁻)E^{(D)}(κ,zᵣ⁻|xₛ)exp(iκ·Xₛ).

Solving for \tilde{E}^{(sc)} gives the “Lorentz deconvolution formula”

\tilde{E}^{(sc)}(κ,zᵣ|Xₛ,zᵣ⁻)=E^{(U)}(κ,zᵣ|xₛ)[E^{(D)}(κ,zᵣ⁻|xₛ)]⁻¹\tilde{E}^{(inc)}(κ,zᵣ|Xₛ,zᵣ⁻). [15]

Equation 15 states that the desired scattered field is found by generalized spectral division between the upgoing and downgoing parts of the electric field, weighted by the incident wavefield of the desired state. The reflectivity of the subsurface can be given in terms of upgoing and downgoing constituents of the electric field as

R=\tilde{E}^{(sc)}\tilde{E}^{(inc)}^{^{−1}}=E^{(U)}E^{(D)}^{^{−1}}.

The Lorentz deconvolution can be expressed in terms of magnetic vector fields instead of electric vector fields. Using the relationships between upgoing and downgoing magnetic and electric vector fields given above yields

\tilde{H}^{(sc)}(κ,zᵣ|Xₛ,zᵣ⁻)=H^{(U)}(κ,zᵣ|xₛ)[H^{(D)}(κ,zᵣ⁻|xₛ)]⁻¹\tilde{H}^{(inc)}(κ,zᵣ|Xₛ,zᵣ⁻),

where \tilde{H}^{(inc)} is the incident magnetic field in the desired state. Since \tilde{H}^{(inc)} is a downgoing field, it is related to \tilde{E}^{(inc)} by

\tilde{H}^{(inc)}=−L₁\tilde{E}^{(inc)}.

Likewise, since \tilde{H}^{(sc)} is an upgoing wavefield, it is related to \tilde{E}^{(sc)} by

\tilde{H}^{(sc)}=L₁\tilde{E}^{(sc)}.

### 1D Isotropic Medium

As a further example, a horizontally layered EM isotropic medium is considered. The wavefield is assumed to propagate in the x₁,x₃-plane such that P₂=0. From Maxwell's equations two uncoupled systems are obtained: one for E₁,H₂ waves, corresponding to EM waves with TM-polarization, and one for E₂, H₁ waves, corresponding to EM waves with TE-polarization. For TM-polarization the downgoing and upgoing waves are computed as

$${E}_{1}^{( D )} = \frac{1}{2} ( {E}_{1} + \frac{{q}_{1}}{\tilde{ɛ}} {H}_{2} ) ; {E}_{1}^{( U )} = {E}_{1} - {E}_{1}^{( D )} .$$

The electric dipole source is oriented along the x₁-axis, giving the incident wavefield

$${\tilde{E}}_{11}^{( inc )} ( κ \vert {χ}_{s} ) = \tilde{a} {G}_{11} exp ( - i κ \cdot {χ}_{s} ) = \frac{\tilde{a} {q}_{1}}{2 \tilde{ɛ}} exp ( - i κ \cdot {χ}_{s} ) .$$

The scattered part of the desired electric field is obtained according to Equation 15 by deterministic spectral deconvolution between the upgoing and downgoing part of the field itself:

\tilde{E}₁₁^{(sc)}(κ,zᵣ|χₛ,zᵣ⁻)=[E₁₁^{(U)}(κ,zᵣ|xₛ)/E₁₁^{(D)}(κ,zᵣ⁻|xₛ)]\tilde{E}₁₁^{(inc)}(κ|χₛ).

The scattered part of the desired magnetic field is correspondingly

\tilde{H}₂₁^{(sc)}(κ,zᵣ|χₛ,zᵣ⁻)=[H₂₁^{(U)}(κ,zᵣ|xₛ)/H₂₁^{(D)}(κ,zᵣ⁻|xₛ)]\tilde{H}₂₁^{(inc)}(κ|χₛ),

where the relationship \tilde{H}^{(inc)}=−L₁\tilde{E}^{(inc)} yields

$${\tilde{H}}_{( 21 )}^{( inc )} = \frac{\tilde{ɛ}}{{q}_{1}} {\tilde{E}}_{11}^{( inc )} = \frac{\tilde{a}}{2} exp ( i κ \cdot {χ}_{s} ) .$$

Multiplication by the incident wavefield is a signature process where the desired electric dipole source with wavelet \tilde{α} acts in the x₁ direction.

For TE-polarizatoin the downgoing and upgoing waves are computed as

$${E}_{2}^{( D )} = \frac{1}{2} ( {E}_{2} - \frac{μ}{{q}_{1}} {H}_{1} ) ; {E}_{2}^{( U )} = {E}_{2} - {E}_{2}^{( D )} .$$

The electric dipole source is oriented along the x₂-axis, giving the incident wavefield

$${\tilde{E}}_{22}^{( inc )} ( κ \vert {χ}_{s} ) = \tilde{α} {G}_{22} exp ( - i κ \cdot {χ}_{s} ) = \frac{\tilde{a} μ}{2 {q}_{1}} exp ( - κ \cdot {χ}_{s} ) .$$

The scattered part of the desired electric field is obtained according to Equation 15 by determisnistic spectral deconvolution between the upgoing and downgoing part of the field itself:

\tilde{E}₂₂^{(sc)}(κ,zᵣ|χₛ,zᵣ⁻)=[E₂₂^{(U)}(κ,zᵣ|xₛ)/E₂₂^{(U)}(κ,zᵣ⁻|xₛ)]\tilde{E}₂₂^{(inc)}(κ|χₛ).

The scattered part of the desired magnetic field is correspondingly

\tilde{H}₁₂^{(sc)}(κ,zᵣ|χₛ,zᵣ⁻)=[H₁₂^{(U)}(κ,zᵣ|xₛ)/H₁₂^{(D)}(κ,zᵣ⁻|xₛ)]\tilde{H}₁₂^{(inc)}(κ|χₛ),

where similarly to the previous derivation,

$${\tilde{H}}_{12}^{( inc )} = - \frac{{q}_{1}}{μ} {\tilde{E}}_{22}^{( inc )} = - \frac{\tilde{a}}{2} exp ( - i κ \cdot {χ}_{s} ) .$$

Multiplication by the incident wavefield is a signature process where the desired electrical dipole source with wavelet \tilde{α} acts in the x₂-direction.

The integral equation (Equation 14) can be modified to give a scheme for designature/denoise for electric field reflection data over 2D laterally inhomogeneous media. For TM-polarization with an electric dipole source oriented along the x₁-axis,

E₁₁^{(U)}(xᵣ|xₛ)=∫_{Σ}dS(χ)r₁₁(Xᵣ|x)E₁₁^{(D)}(x|xₛ),

where r₁₁ is the inverse Fourier transform of R₁₁, becoming

$${R}_{11} = \frac{2 \tilde{ɛ}}{\tilde{a} {q}_{11}} {\tilde{E}}_{11}^{( sc )} = {[ {\tilde{E}}_{11}^{( inc )} \vert {χ}_{s = 0} ]}^{- 1} {\tilde{E}}_{11}^{( sc )} .$$

For the magnetic field, the corresponding designature/denoise scheme is

H₂₁^{(U)}(xᵣ|xₛ)=∫_{Σ}dS(χ)r₂₁^{H}(xᵣ|x)H₂₁^{(D)}(x|xₛ),

where r₂₁^{H} is the inverse Fourier transform of R₂₁^{H}, becoming

R₂₁^{H}=[\tilde{H}₂₁^{(inc)}|χₛ₌₀]⁻¹\tilde{H}₂₁^{(sc)}.

For TE-polarization with an electric dipole source oriented along the x₂-axis,

E₂^{(U)}(xᵣ|xₛ)=∫_{Σ}dS(χr₂₂(xᵣ|x)E₂₂^{(D)}(x|xₛ),

where r₂₂ is the inverse Fourier transform of R₂₂, becoming

$${R}_{11} = \frac{2 \tilde{ɛ}}{\tilde{a} {q}_{1}} {\tilde{E}}_{11}^{( sc )} = {[ {E}_{11}^{( inc )} \vert {χ}_{s = 0} ]}^{- 1} {\tilde{E}}_{11}^{( sc )} .$$

For the magnetic field, the corresponding designature/denoise scheme is

H₁₂^{(U)}(xᵣ|xₛ=∫_{Σ}dS(χ)r₁₂^{H}(xᵣ|x)H₁₂^{(D)}(x|xₛ),

where r₁₂^{H} is the inverse Fourier transform of R₁₂^{H}, becoming

R₁₂^{H}=[\tilde{H}₁₂^{(inc)}|χₛ₌₀]⁻¹\tilde{H}₁₂^{(sc)}.

### Wavefield Decomposition Just Above Sea Bed

The Lorentz designature/denoise method described above replaces the medium from the receiver depth level and upwards with a homogeneous overburden. In the previous sections, the receiver depth level was defined to be just below the sea bed by using the continuity of the horizontal components of the EM field across the sea bed interface. In this case, Lorentz designature/denoise processing gives idealised data without any events caused by the water layer and sea bed.

However, instead of decomposing EM data into upgoing and downgoing waves just below the sea bed, the EM data can be decomposed just above the sea bed. In this case, the surface Σ must be located infinitesimally above the depth of the wavefield decomposition. It follows that the Lorentz designature/denoise scheme replaces the water column and sea surface by a homogeneous water layer halfspace. This is illustrated in FIG. 3c. Although the effects of the water column and sea surface are eliminated, Lorentz designature/denose processing will not remove any effects related to the sea bed. A disadvantage of applying the Lorentz designature/denoise scheme just above the sea bed is that reflections and refractions from the incident wavefield due to the point source of electric current will be present in the Lorentz designature/denoise data. These reflections will interfere with reflections and refractions from high-resistivity layers in the subsurface and may render the interpretation difficult. The solution to eliminate the sea bed reflection is to follow Lorentz designature/denoise processing with a further up/down wavefield decomposition step below the sea bed.

### Redatuming

The designature/denoised field as described above has been derived for the desired point source of electric current located just above the receiver plane. In marine EM-SBL the source is located a distance Zᵣ-zₛ above the receivers. The desired data can be redatumed to simulate acquisition from the physical source depth. Since the desired data are an upgoing wavefield, the redatuming is effected by multiplying the upgoing wavefield by a phase shift operator

exp[iωq(zᵣ-zₛ)]

The reciprocity theorem provides the theoretical basis for eliminating the physical response of a medium above a receiver level where EM waves are measured in a multi-component source, multi-component receiver experiment. The reciprocity theorem gives a procedure for transforming wavefields recorded in the physical EM experiment with the water layer overburden response present into wavefields that would have been recorded in the hypothetical EM experiment with the water layer overburden response absent. The transform process is called Lorentz designature/denoise. Other than the position of the sources, no source characteristics are required to eliminate all EM waves scattered from the water layer overburden. The radiation characteristics of the physical multi-component source are eliminated by a multidimensional source designature operation in the transformation from the physical experiment into the hypothetical experiment.

The Lorentz designature/denoise method requires that the physical wavefield is properly decomposed into upgoing and downgoing waves. Further the method of the embodiments requires no knowledge of the medium below or above the receiver level; and requires information only of the local and physical parameters along the receiver spread. The method additionally preserves primary amplitudes while eliminating all waves scattered from the water layer overburden.

The Lorentz designature/denoise method is set out in the flowchart of FIG. 5. At step 20, EM data is acquired at at least one receiver. The data is then decomposed (step 21) into upgoing and downgoing components. The multidimensional designature and denoise operator that eliminates the response of the water layer overburden is computed at step 22 from the downgoing constituents of the multi-component data measurements. An integral equation is formulated at step 23 using the upgoing constituents of the multi-component field recording together with the multidimensional operator computed at step 22, and the desired source wavelet 23 for the electric current. The integral equation is solved at step 25 to give designature EM components with all of the waves scattered in the physical water layer overburden removed.

In the case when the medium is anisotropic and horizontally layered, the Lorentz designature/denoise scheme greatly simplifies, and is conveniently implemented as a deterministic multidimensional deconvolution of common shot gathers (or common receiver gathers when source array variations are negligible). When the medium is isotropic and horizontally layered, the Lorentz designature/denoise decouples on the source side into TE and TM problems, with scalar field designature/denoise (deconvolution) processes.

The schematic diagram of FIG. 6 illustrates a central processing unit (CPU) 33 connected to a read-only memory (ROM) 30 and a random access memory (RAM) 32. The CPU is provided with data 34 from the receivers via an input/output mechanism 35. The CPU then performs the wavefield decomposition 36, computes the signal removal operator from the downgoing components, and formulates and solves (numerically or analytically) the integral equation to provide the designatured data 37 in accordance with the instructions provided by the program storage 31 (which may be part of the ROM 30). The program itself, or any of the input and/or outputs to the system may be provided or transmitted to/from a communication network 38, which may be, for example, the Internet.

It will be appreciated by the skilled person that various modifications may be made to the above embodiments without departing from the scope of the present invention as deifned in the appended claims.

1. A method of processing multi-component, multi-offset electromagnetic data measured at at least one multi-component receiver, the data representative of electric and magnetic fields due to a source, the at least one multi-component receiver being disposed at a depth greater than that of the source, the method comprising:
decomposing the measured multi-offset electric and magnetic fields into upgoing and downgoing components; and
formulating a noise removal operator from the downgoing components and the properties of the medium surrounding the at least one receiver.

2. A method as claimed in claim 1, comprising the further step of applying the noise removal operator to the measured electric and magnetic fields to attenuate the electric and magnetic fields due to the media at a depth less than that of the at least one receiver.

3. A method as claimed in claim 1, comprising the further step of applying the noise removal operator to the upgoing components to attenuate the electric and magnetic fields due to (i) the media at a depth less than that of the at least one receiver, and (ii) the source.

4. A method as claimed in claim 1, wherein the noise removal operator is formulated using electromagnetic wave theory.

5. A method as claimed in claim 4, wherein the noise removal operator is formed using the electromagnetic reciprocity theorem between a first state and a second state.

6. A method as claimed in claim 5, wherein the first state is the physical environment and the second state is a hypothetical environment in which the at least one receiver is bounded above by a homogeneous medium.

7. A method as claimed in claim 6, wherein the homogeneous medium is free space.

8. A method as claimed in claim 1, wherein the noise removal operator performs a multidimensional signature deconvolution process.

9. A method as claimed in claim 1, wherein the decomposition of the measured data into upgoing and downgoing components is performed immediately beneath a horizontal plane in which the at least one receiver is disposed.

10. A method as claimed in claim 1, wherein the decomposition of the measured data into upgoing and downgoing components is performed immediately above a horizontal plane in which the at least one receiver is disposed.

11. A method as claimed in claim 1, wherein the electromagnetic data is electromagnetic sea bed logging data.

12. A method as claimed in claim 11, comprising the further step of redatuming the electromagnetic data using a phase shift operator.

13. A method as claimed in claim 1, wherein the source emits multicomponent electromagnetic energy.

14. A method as claimed in claim 1, wherein the source emits single-component electromagnetic energy.

15. An apparatus for processing electromagnetic data, comprising:
a source for generating electric and magnetic fields;
at least one receiver disposed at a depth greater than that of the source for measuring electric and magnetic fields;
means for decomposing the measured fields into upgoing and downgoing components; and
means for formulating a noise removal operator from the downgoing components and the properties of the medium surrounding the at least one receiver.

16. A program for controlling a computer to perform a method as claimed in claim 1.

17. A program as claimed in claim 16 stored in a storage medium.

18. Transmission of a program as claimed in claim 16 across a communication network.

19. A computer programmed to perform a method as claimed in claim 1.
